(19) United States
(12) Patent Application Publication
(10) Pub. No.: US 2017/0108875 A1
(43) Pub. Date: Apr. 20, 2017

(54) Vehicle Control System

(71) Applicant: General Electric Company, Schenectady, NY (US)

(72) Inventors: Michael Ross, Hiram, GA (US); Paul Davis, Powder Springs, GA (US); Neil Linton, Altanta, GA (US)

(21) Appl. No.: 15/299,844

(22) Filed: Oct. 21, 2016

Related U.S. Application Data
(63) Continuation-in-part of application No. 13/940,441, filed on Jul. 12, 2013, now abandoned.
(60) Provisional application No. 61/674,618, filed on Jul. 23, 2012.

(51) Int. Cl. G05D 1/02; G07C 5/00; G06F 17/30; G05B 19/042; H04L 29/08; G08G 7/00

(52) U.S. Cl. CPC G05D 1/0291; H04L 67/12; G08G 7/00; G06F 17/30365; G05B 19/042; G07C 5/008; G05B 2219/2637

(57) ABSTRACT

A system includes a communication system for wireless communication with a vehicle, and one or more processors coupled to the communication system. The one or more processors are configured to determine that a first portion of vehicle information for the vehicle is altered from a first value to a second value that is different than the first value, route the first portion of the vehicle information (that is altered to the second value), route a second portion of the vehicle information that is not altered (i.e., not altered to the second value), store the first portion and the second portion in a vehicle record that represents a status of the vehicle, and generate control signals, for communication over the communication system to the vehicle, to control movement of the vehicle based on the first portion and the second portion stored in the vehicle record.

### BACKGROUND

Field

The subject matter disclosed herein relates to vehicle control systems.

Discussion of Art

A railroad yard, a shipping port, a warehouse, or a rental car parking lot may have vehicles (e.g., rail cars, marine vessels, trailers, automobiles, etc.) located throughout which are to be managed in various ways (e.g., moved, loaded, stacked, linked, assigned, rented). A vehicle may have information associated with the vehicle that is distributed across many locations, such as many different files in a database of a transportation management system (TMS). Pieces of the vehicle information may get updated in the database in an unpredictable manner, making it difficult to know when new information is available or if currently accessed information is current or old information.

### BRIEF DESCRIPTION

In one embodiment, a system includes a communication system configured for wireless communication with a first vehicle, a memory that stores computer-executable instructions, and one or more processors coupled to the memory and to the communication system. The one or more processors are configured to execute or facilitate execution of the computer-executable instructions to at least determine that a first portion of first vehicle information for the first vehicle is altered from a first value to a second value that is different than the first value, route (from a first data source via a computer network) the first portion of the first vehicle information that is altered to the second value, route (from a second data source via the computer network) a second portion of the first vehicle information that is not altered to the second value, store the first portion and the second portion in a first vehicle record that represents a status of the first vehicle, and generate control signals, for communication over the communication system to the first vehicle, to control movement of the first vehicle based on the first portion and the second portion stored in the first vehicle record.

In one embodiment, a system includes a communication system and a vehicle system configured to receive, over the communication system, vehicle information provided by a plurality of data sources and to store the vehicle information in a distributed manner across a plurality of database files. The vehicle system is configured to generate a trigger event in response to a determination that a first portion of the vehicle information corresponding to a first vehicle changes within the vehicle system. The system also includes a controller having one or more processors and configured to communicate with the vehicle system via the communication system. The controller is configured to update, in response to sensing the trigger event, a determined set of fields of a vehicle record corresponding to the first vehicle by obtaining the first portion of the vehicle information corresponding to the first vehicle from a first database file of the plurality of database files and obtaining a second portion of the vehicle information corresponding to the first vehicle from a second database file of the plurality of database files. The controller is configured to generate control signals, based on the first portion and the second portion of the vehicle information, relating to control of the first vehicle.

In one embodiment, a system includes a vehicle system configured to receive, via a communication system, vehicle information provided by plural, different data sources disposed in different geographic locations and to store the vehicle information in a distributed manner across plural database files. The system also includes a controller having one or more processors and configured to communicate with the vehicle system via the communication system. The controller is configured to update, in response to sensing a trigger event generated by the vehicle system, a determined set of fields of a vehicle record corresponding to the first vehicle by obtaining the first portion of the vehicle information corresponding to the first vehicle from a first database file of the plural database files and obtaining a different, second portion of the vehicle information corresponding to the first vehicle from a second database file of the plural database files. The controller also is configured to generate control signals, based on the first portion and the second portion of the vehicle information, for controlling movement of the first vehicle.

### BRIEF DESCRIPTION OF THE DRAWINGS

Reference is made to the accompanying drawings in which particular embodiments of the inventive subject matter are illustrated as described in more detail in the description below, in which:

FIG. 1 is a schematic block diagram of one embodiment of a vehicle control system;

FIG. 2A illustrates a schematic diagram of one embodiment of a vehicle database of the vehicle control system of FIG. 1;

FIG. 2B illustrates a schematic diagram of one embodiment of a vehicle record file of the vehicle control system of FIG. 1;

FIG. 3 illustrates a schematic block diagram of one embodiment of the vehicle control system of FIG. 1 where a controller of FIG. 1 is configured as a vehicle management controller (VMC) and a vehicle database system of FIG. 1 is configured as a transportation management system (TMS);

FIG. 4 illustrates a functional block diagram of one embodiment of the vehicle control system of FIG. 3;

FIG. 5 illustrates a flowchart of one embodiment of a vehicle control method; and

FIG. 6 illustrates one embodiment of a user interface presenting a map view of a vehicle zone provided by the system of FIG. 3 which is updated in accordance with the method of FIG. 5.

### DETAILED DESCRIPTION

Embodiments of the inventive subject matter relate to systems providing for the timely updating of vehicle information from disparate data sources to a vehicle record that may be accessed by a computer-based application for control of a vehicle. The systems described herein may be discussed in the context of a vehicle yard or terminal of a vehicle transportation system with vehicles, such as rail vehicles (locomotives and/or rail cars), automobiles, trailers, marine vessels, barges, mining vehicles, or other off-highway vehicles (e.g., vehicles that are not designed or are not legally permitted to travel along public roadways). The vehicle yard may include a rail yard, warehouse, shipping port, mining site, rental car lots, parking lots, etc. A vehicle consist is a group of vehicles that are mechanically linked together or logically linked together to travel along one or more routes. The vehicles may be logically linked with each other by being mechanically separate or decoupled, but communicating with each other to coordinate their movements.

The vehicles can include containers and/or trailers, which can include storage media that hold products, goods, or other shippable materials. The vehicle yards also may be referred to as vehicle zones, and can include locations, sites, areas, or facilities where vehicles are managed. The managing of vehicles may include, for example, moving, loading, stacking, linking, assigning, renting, and shipping the vehicles. Configuring, stacking, and building the vehicles may be used interchangeably to refer to virtually or actually creating a profile of containers/trailers on vehicles.

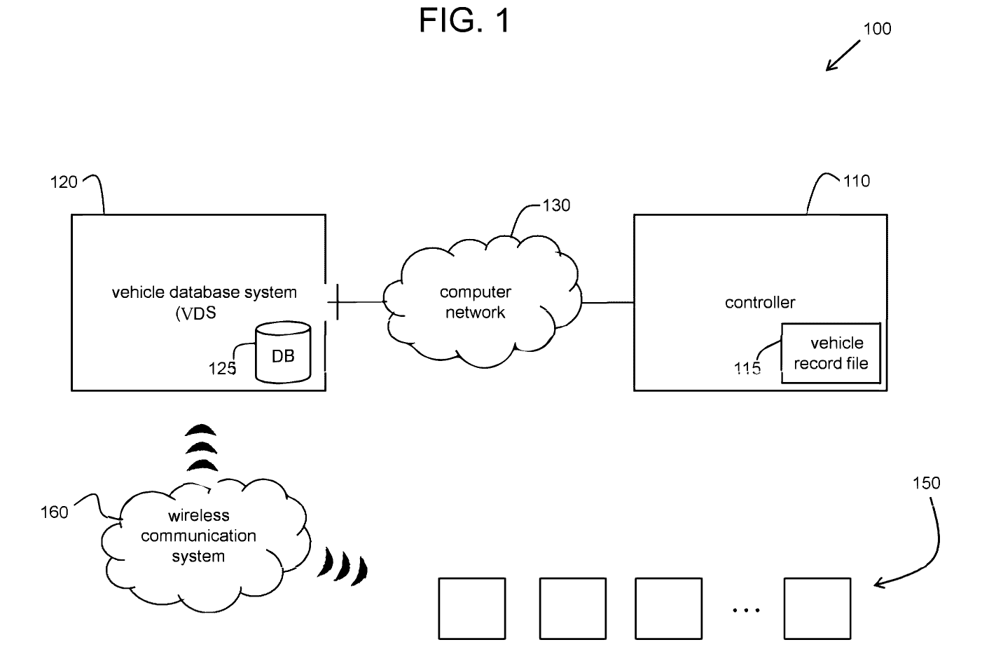

FIG. 1 is a schematic block diagram of one embodiment of a vehicle control system 100. The vehicle control system 100 may be used to gather updated vehicle information in real time from disparate data sources as the vehicle information changes, and make the updated vehicle information available to other applications in a record. Operations of the vehicle may be controlled (e.g., autonomously) based on the updated information. The system 100 includes a controller 110 having at least one vehicle record file 115. The controller refers to a system that includes the logic circuitry, memory, and/or processing devices and associated software, modules or programs for performing the operations described herein. The record file 115 contains information on a plurality of vehicles which is kept up-to-date by the controller 110. In accordance with an embodiment, all information for a vehicle is recorded in a vehicle record for that vehicle, forming a comprehensive record of vehicle information. For example, the record may be a complete set or an entire collection of the vehicle information, or a largely complete set or most of the vehicle information. As a result, an application having access to the vehicle records may obtain all of the available information for a vehicle from the corresponding vehicle record.

The data may be gathered in real time in that the vehicle information is obtained in a timely manner, or is obtained immediately in response to some event (e.g., the event represented by the vehicle information). For example, actions may be taken to update vehicle information in a vehicle record immediately following a change in the vehicle information in a database file. The vehicle information may be updated by replacing or supplementing at least part of the vehicle information with more recent vehicle information.

The system also includes a vehicle database system (VDS) 120 having at least one database (DB) 125. The database 125 contains information on a plurality of vehicles, where the vehicle information is distributed across a plurality of files in the database 125. For example, the VDS 120 may be in the form of a transportation management system in accordance with an embodiment, and the vehicle information may be, at least in part, waybill information that is configured in a waybill structure across files of the database 125.

In accordance with an embodiment, the VDS 120 obtains vehicle information from a plurality of vehicles 150 via one or more wireless communication systems 160 that communicate the vehicle information from the plurality of vehicles 150 to the VDS 120. The plurality of vehicles may include locomotives, mining equipment, construction equipment, rail cars, marine vessels, or automobiles, for example. The wireless communication systems 160 may be one or more radio frequency communication systems. Other types of wireless communication systems are possible as well, in accordance with various embodiments.

Several data sources 170 are operably coupled with the vehicles 150 in order to provide the vehicle information to the VDS 120. In one embodiment, the data sources 170 are separate sources of the information in that the data sources 170 are disposed onboard different vehicles 150. Two or more of the data sources 170 may be disparate data sources in that the data sources 170 provide different vehicle information. One or more vehicles 150 may include disparate data sources 170 that measure different characteristics of the vehicle 150 or that measure the same characteristic, but in a different manner, as the vehicle information. For example, one data source 170 may be a global positioning system receiver determining and communicating a geographic location and/or moving speed of the vehicle 150 as the vehicle information, another data source 170 onboard the same vehicle 150 may be a tachometer measuring and providing the moving speed of the vehicle 150 as the vehicle information, another data source 170 may be an oil level sensor determining the amount of lubricant in an engine or other system of the vehicle 150 as the vehicle information, another data source 170 may be an accelerometer determining vibrations or accelerations of the vehicle 150 as the vehicle information, etc. Other data sources 170 may be input devices (e.g., keyboards, touchscreens, etc.) through which the vehicle information is received. Another example of a data source 170 may be a camera that is coupled with a vehicle to obtain images and/or video as the vehicle information, or a camera that is not coupled with a vehicle to obtain images and/or video of a vehicle as the vehicle information.

One or more of the vehicles 150 may include controllers 180 that represent hardware circuitry that includes and/or is connected with one or more processors (e.g., microprocessors, field programmable gate arrays, and/or integrated circuits) that can control movement of the vehicles 150. For example, the controllers 180 can receive control signals that direct different throttle settings, brake settings, movement directions, etc., and can automatically control engines, motors, brakes, etc., of the vehicles 150 based on the control signals. The control signals may be received from an operator onboard a vehicle 150. Optionally, the control signals may be received from an off-board location, such as from the controller 110, as described below.

In accordance with an embodiment, the controller 110, the data sources 170, and/or the VDS 120 are configured to communicate with each other through, for example, one or more communication networks 130 (e.g., one or more computer networks). The communication network may include one or more server computers, for example. The computers or processors or processing elements or computer devices described herein include, but are not limited to, any programmed or programmable electronic device that can store, retrieve, and process data. Alternatively, the controller 110, data sources 170, and/or the VDS 120 may communicate directly with each other (e.g., not through a computer network), for example, through wired and/or wireless connections. The controller 110 is operable to access vehicle information provided by the data sources 170 from the VDS 120 to update a record of the vehicle record file 115.

In one embodiment, the vehicles 150 and/or data sources 170 may communicate with the vehicle database system 120 via the wireless communication system 160 using at least a first communication protocol while the controller 110 may communicate with the vehicle database system 120 via the computer network 130 using at least a second communication protocol that is different from the first communication protocol. The different protocols may designate different rules or criteria for communications, such as different semantics, syntaxes, times at which communications occur, sizes of communications (e.g., data packets), the order of information within communications, etc., such that the vehicles 150 and/or data sources 170 may not be able to communicate with the vehicle database system 120 using the second protocol and/or the controller 110 may not be able to communication with the vehicle database system 120 using the first communication protocol.

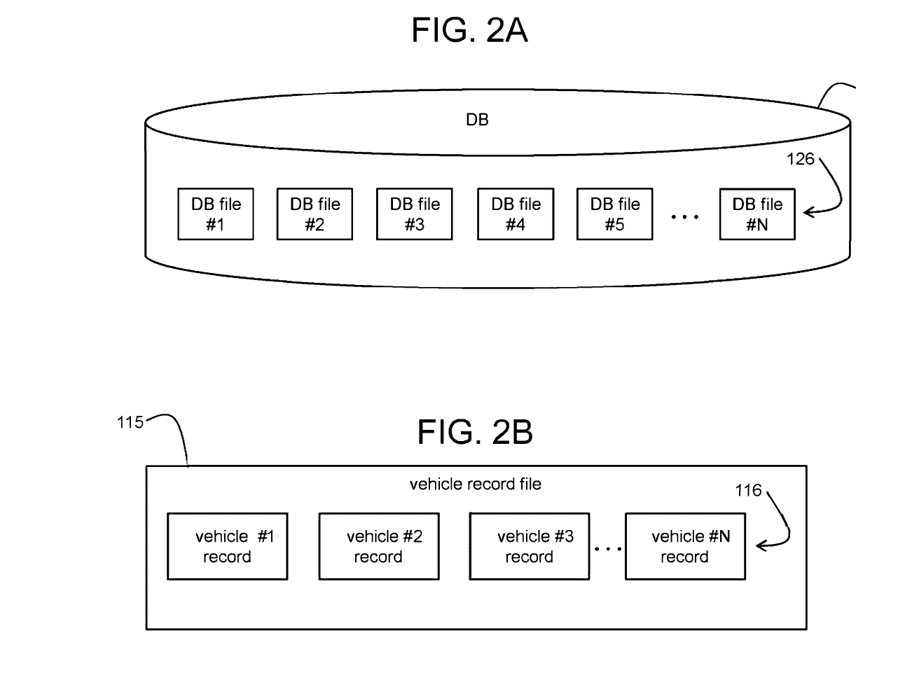

FIG. 2A illustrates a schematic diagram of one embodiment of a vehicle database 125 of the vehicle control system 100 of FIG. 1. The database 125 represents one or more non-transitory computer-readable media, such as, but not limited to, a computer hard drive, an optical disc, a removable flash memory card, a magnetic tape, etc. The database 125 stores and is distributed across a plurality of database files 126 (“DB file #1,” “DB file #2,” and so on, in FIG. 2A), where information for a vehicle 150 may be distributed across many of the plurality of database files 126. For example, DB file #2 may store vehicle maintenance information for a plurality of vehicles (e.g., dates and/or times that repairs on the vehicles 150 were performed, which repairs were performed, when upcoming repairs are due, which repairs need to be performed, etc.), and DB file #3 may store vehicle billing information for the plurality of vehicles. The other database files may store other types of information for the same plurality of vehicles, where each database file corresponds to a particular type of vehicle information. As a result, all of the vehicle information for any one vehicle cannot be obtained from a single database file (single data source) since the vehicle information is distributed across many database files. In accordance with an embodiment, at least a portion of the plurality of database files may be stored in a cloud-based system, such as a system where at least a portion of the system (e.g., file storage) is located remotely and may be accessed via a computer network.

Embodiments of the inventive subject matter provide for the gathering of vehicle information for a particular vehicle such that the gathered vehicle information may be presented in a vehicle record. Therefore, an application needing access to the vehicle information for a vehicle can obtain the vehicle information from a vehicle record, instead of having to, for example, search many files across the entire database 125.

FIG. 2B illustrates a schematic diagram of one embodiment of a vehicle record file (VRF) 115 of the vehicle control system 100 of FIG. 1. The vehicle record file 115 contains one unique vehicle record 116 of vehicle information for each particular vehicle in an inventory. A vehicle record may have a determined set of fields of different types of vehicle information (e.g., make and model of the vehicle, mileage on the vehicle, next scheduled repair and/or previous repairs, etc.) that may be updated by the controller. For example, in a rail yard environment where the vehicles are rail cars, each vehicle record 116 may contain a comprehensive set of vehicle information for a unique rail car for the current inventory that is on-line in the rail yard. Each vehicle record 116 may contain one-hundred data fields, for example, where the data representative of the vehicle information used to populate the one-hundred data fields is distributed across the database files of the vehicle database system 120.

Again, embodiments of the inventive subject matter gather vehicle information for a vehicle from across many files in the VDS 120 and populate the data fields of the corresponding vehicle record 115 with the vehicle information. In this manner, an application needing access to the vehicle information for a particular vehicle can obtain the vehicle information from a vehicle record, instead of having to, for example, search many files across the entire database 125. The gathering and updating of the vehicle information for a vehicle is accomplished in real time, in accordance with various embodiments, such that the most up-to-date information for a vehicle is always available in the vehicle record 115 for that vehicle.

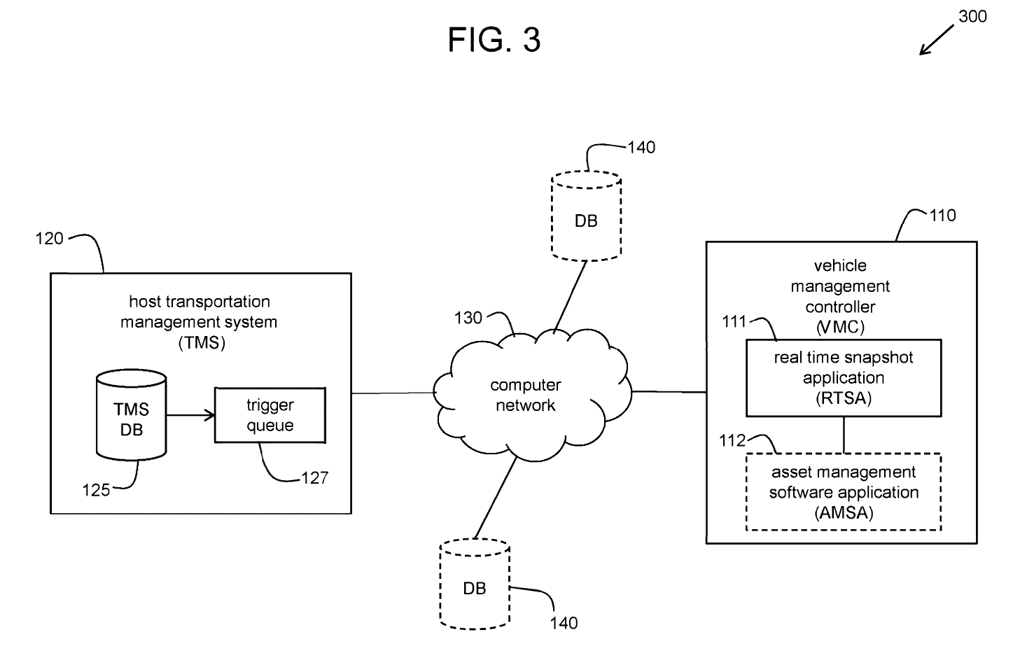

FIG. 3 illustrates a schematic block diagram of one embodiment of a vehicle control system 300 that is similar to the vehicle control system 100 of FIG. 1. One difference between the vehicle control systems 100, 300 is that the controller 110 in the vehicle control system 300 is configured as a vehicle management controller (VMC) and the vehicle database system 120 is configured as a transportation management system (TMS). The system 300 includes a computer network 130 facilitating operable communication between the TMS 120 and the VMC 110. The system 300 may optionally include one or more additional databases 140. In accordance with an embodiment, the TMS database 125 is part of the transportation management system 120 and the database(s) 140 is a database for an accounts receivable and/or an accounts payable system.

The TMS 120 may be configured to manage various aspects (e.g., scheduling, tracking, way billing, revenue accounting) of a larger transportation system such as, for example, an entire railroad. Therefore, the TMS 120 may communicate with a plurality of vehicle management controllers 110 at a plurality of vehicle zones. The TMS 120 includes a TMS database 125 and a trigger queue 127. The trigger queue 127 is a data structure that uses computer memory to record trigger events generated by the TMS 120. For example, the one or more processors of the vehicle controller The VMC 110 hosts a real time snapshot application (RTSA) 111 and, optionally, a vehicle management software application (VMSA) 112 that operatively communicates with the RTSA 111.

The RTSA 111 is a software application that is operable to execute on the VMC 110 to update vehicle records 116 of the vehicle file 115 on the VMC 110 as is described in detail later herein. The software application includes, but is not limited to, one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, an application, instructions stored in a memory, part of an operating system or other type of executable instructions. The form of software depends on, for example, requirements of a desired application, the environment it runs on, and/or the desires of a designer/programmer or the like.

The VMSA 112 may be one of many software applications that are configured to access and read vehicle records 116 from the RTSA 111. For example, in accordance with an embodiment, the VMC 110 is implemented as a server computer running the VMSA 112. The VMC 110, running the VMSA 112, manages vehicles within a vehicle zone (e.g., the assignment, loading, and movement of vehicles within a vehicle yard) and provides graphical mapping that allows visualization of the vehicle zone by a user on a display screen of a personal computer, for example. The RTSA 111, also running on the VMC 110, provides access of up-to-date vehicle information to the VMSA 112, as described herein.

In accordance with various other embodiments of the inventive subject matter, the system 300 may be configured in various other ways. For example, the vehicle management controller may be co-located with or be implemented on a same server computer as the TMS. As another example, the vehicle management controller may be hosted at a third party site (e.g., a provider of the VMSA) as a software-as-a-service (SaaS) configuration. Other configurations are possible as well, in accordance with various other embodiments of the inventive subject matter described herein.

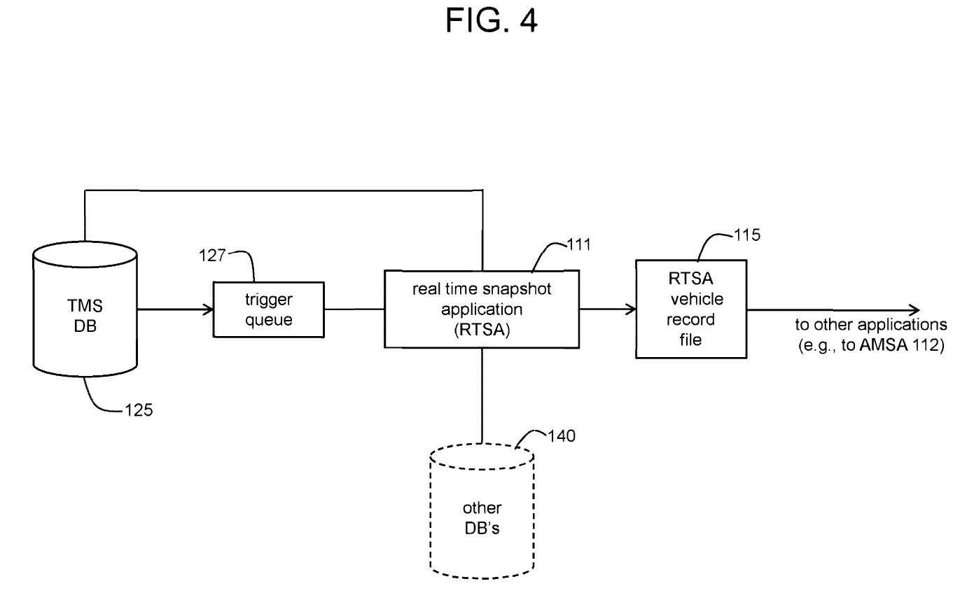

FIG. 4 illustrates a functional block diagram of one embodiment of the system 300 of FIG. 3. In accordance with an embodiment, various triggers are set up in the TMS database system 120 such that, when a determined piece or field of information for a vehicle changes or is updated (e.g., changes from a first value to a second, different value) within a file 126 of the TMS database 125, a trigger event is generated by the TMS 120. A trigger event may include, but is not limited to, setting a data flag, outputting a message, or outputting a code.

When the trigger event is generated, the TMS 120 outputs vehicle identification information associated with the vehicle to the trigger queue 127. The RTSA 111, monitoring the trigger queue 127, senses or determines a change in the trigger queue 127 and reads vehicle identification information in the trigger queue 127. In accordance with an embodiment, the vehicle identification information may include a primary key for the vehicle having a unique control number, a vehicle initial (e.g., a rail car initial), and/or a vehicle number (e.g., a rail car number, a vehicle identification number, etc.). Other identifying information (e.g., a waybill code) may be used depending on application specific parameters. Furthermore, in accordance with an embodiment, additional information such as the type or category of data that has changed may be output to the trigger queue 127 as well.

The RTSA 111 then uses the vehicle identification information to gather vehicle information corresponding to the vehicle from the various database files 126 of the TMS DB 125, and possibly from files of other databases 140 as well. In this manner, in response to the trigger event, all available vehicle information (or some subset thereof), including the piece of vehicle information that changed and triggered the trigger event, may be gathered by the RTSA 111 and updated into the fields of the corresponding vehicle record 116 for the vehicle. The RTSA 111 does not have to know or be informed of which particular piece of vehicle information actually changed and caused the trigger event. In accordance with an embodiment, the RTSA 111 operates in the background. For example, the processing bandwidth consumed by the RTSA 111 is sufficiently low to allow other applications (operating systems, safety monitoring systems, diagnostic systems, etc.) to continue operating with sufficient processing bandwidth without hampering or interfering with operation of the other applications. As a result, up-to-date vehicle information is always available to other applications (e.g., to the AMSA 112) in a vehicle record 116 for any given vehicle. Vehicle information may include waybill information, location information, content (e.g., identification and/or amounts of cargo being carried by the vehicle), vehicle weight, and/or other types of vehicle information, in accordance with various embodiments.

In accordance with an embodiment, a subset of data fields of the plurality of database files may be periodically queried by the database system and, if there is no change in the values of the subset of data fields, a trigger event is not initiated. For example, the trigger event may occur responsive to the vehicle information changing (e.g., being added to and/or being updated). Furthermore, if one or more data sources of the database system are unavailable to provide updated vehicle information, the comprehensive vehicle information in a vehicle record may be annotated to indicate the inability to update the vehicle record.

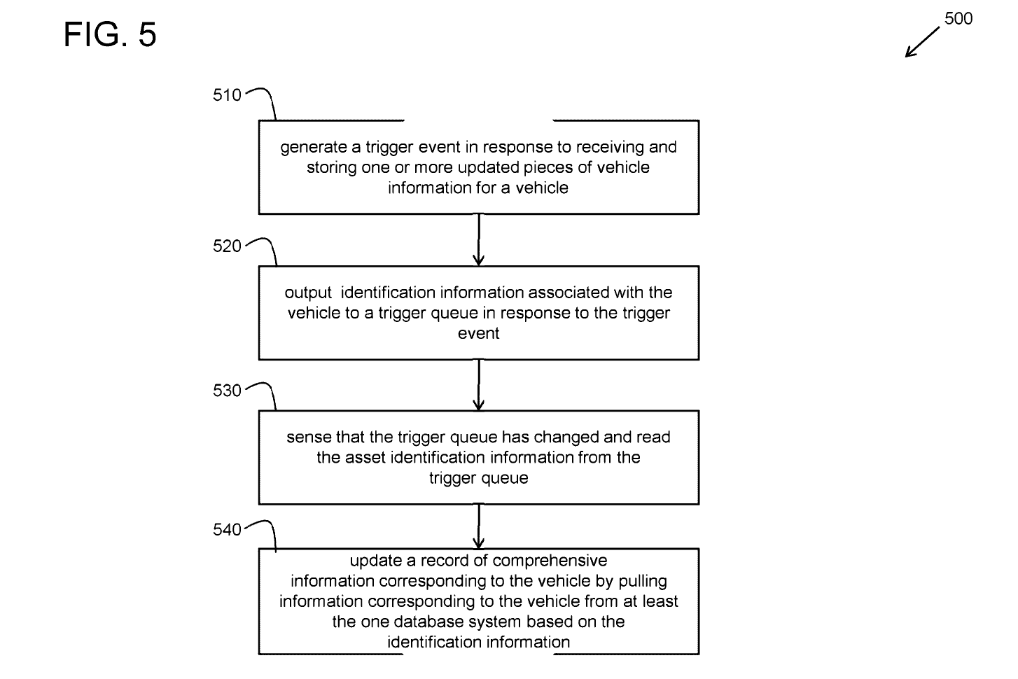

FIG. 5 illustrates a flowchart of one embodiment of a method 500 to update a record 116 of comprehensive vehicle information for a vehicle using the system 300 of FIG. 3, in accordance with the functional block diagram of FIG. 4. At 510, a database system generates a trigger event in response to receiving and storing one or more updated pieces of vehicle information for a vehicle. At 520, the database system outputs vehicle identification information associated with the vehicle to a trigger queue in response to the trigger event. At 530, a controller senses that the trigger queue has changed and reads the vehicle identification information from the trigger queue. At step 540, the controller updates a record of comprehensive vehicle information corresponding to the vehicle by obtaining information corresponding to the vehicle from at least the database system based on the identification information.

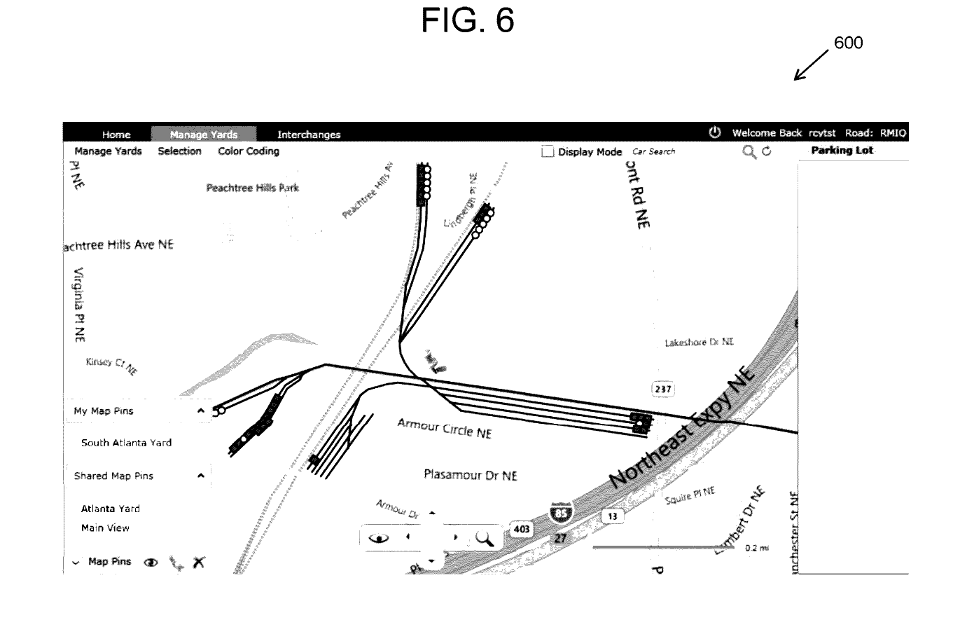

As an example, FIG. 6 illustrates one embodiment of a graphical user interface 600 illustrating a map view of a vehicle zone provided by the system 300 of FIG. 3 which may have information updated in accordance with the method 500 of FIG. 5. The map view is a graphic representation of a vehicle yard and routes overlaid on a map of the area. In accordance with an embodiment, a refresh icon is provided in the map view, allowing a user to update the view to show the current inventory (e.g., vehicles) in the yard as overlaid icons.

The updated vehicle information is received by the controller 110 from the TMS 120, in accordance with methods described herein, and processed by the AMSA 112 to refresh the view on a display screen of the user computer (not shown). Vehicle information may be presented in visual form as, for example, icons on a map overlay of the yard or zone. In accordance with an embodiment, the icons provide cues and clues about the status and location of a vehicle (e.g., a rail car, locomotive, or container/trailer) which may include a vehicle identification (ID) code, a cargo type, a destination, an origination, a container type, vehicle health, equipment status, maintenance status, and/or load status. Also, in accordance with an embodiment, a user may hover a cursor over a vehicle icon to display and view other vehicle information (e.g., in textual form) associated with that vehicle. For example, changed vehicle information may be selectively displayed to the user. Furthermore, a user may be alerted that the vehicle information has changed. For example, a rule set may be applied that indicates an imminence, severity, or magnitude of the changed vehicle information. As a result, using the systems and methods described herein, up-to-date vehicle information can be provided to applications and users to facilitate the management of vehicles within a vehicle zone.

Optionally, the vehicle information that is obtained from different data sources can be used for purposes other than mapping locations of the vehicles. As one example, the vehicle information may be used to order or initiate repair or inspection of a vehicle. The vehicle information may be examined by the controller 110 and, responsive to the vehicle information indicating a need for repair or inspection, the controller 110 may automatically communicate one or more control signals to a repair facility and/or the vehicle needing repair and/or inspection. Responsive to receiving the control signal(s), the vehicle may move to the repair facility and/or the repair facility may initiate repair and/or inspection of the vehicle. As another example, the vehicle information may be used to order one or more replacement parts for the vehicle. The vehicle information may be examined by the controller 110 and, responsive to the vehicle information indicating a need for replacement of a part, the controller 110 may automatically communicate one or more control signals to the repair facility and/or the vehicle needing the replacement part. Responsive to receiving the control signal(s), the vehicle may move to the repair facility and/or the repair facility may obtain (e.g., order or obtain from an inventory) the replacement part.

In one embodiment, a controller is provided that is operable to route vehicle information for a vehicle to a vehicle record in response to at least a portion of the vehicle information changing from a first value to a second, different value. The vehicle information is obtained from a plurality of data sources and the vehicle record represents a status of the vehicle at the time of the change from the first value to the second value. The controller may be operable to respond to a query of a current status of the vehicle by referring to the vehicle record of the vehicle, and not to the plurality of data sources. For example, instead of the controller communicating with the data sources to receive the vehicle information, a portion of the vehicle information, or an update to the vehicle information, the controller may obtain the vehicle information, portion of the vehicle information, and/or update to the vehicle information from the vehicle record, which is created from the information provided by the data sources. The controller may be operable to route (e.g., send or store) vehicle information for a plurality of vehicles to a corresponding vehicle record for each vehicle of the plurality of vehicles when at least a portion of the vehicle information changes for a vehicle, where the vehicle information for each vehicle is obtained from the plurality of data sources.

In one embodiment, a system is provided that includes a controller as discussed above, and at least one vehicle database system distributed across a plurality of database files which includes the vehicle information for a plurality of vehicles, and that is operable to communicate with the controller. The vehicle database system may include a TMS and the controller may include an AMC having an AMSA. The controller may further be operable to determine when one or more determined pieces of vehicle information for a vehicle changes in the vehicle database system, and to comprehensively update a vehicle record corresponding to the vehicle by pulling vehicle information corresponding to the vehicle from at least the vehicle database system. The system may further include a communication network configured to provide communications between the vehicle database system and the controller. At least a portion of the plurality of database files may be stored in a cloud-based system, and the communication network may include one or more server computers.

In one embodiment, a system is provided that includes a plurality of vehicles configured to provide vehicle information. The system also includes a vehicle database system configured to receive the vehicle information and store the vehicle information in a distributed manner across a plurality of database files. The vehicle database system is operable to generate a trigger event when one or more pieces of vehicle information corresponding to a vehicle changes within the vehicle database system. The system further includes a controller configured to communicate with the vehicle database system. The controller is operable to update a determined set of fields of a vehicle record corresponding to the vehicle by pulling vehicle information corresponding to the vehicle from one or more database files of at least the vehicle database system into the vehicle record in response to sensing the trigger event. The system may also include a wireless communication system configured to communicate the vehicle information from the plurality of vehicles to the vehicle database system. The plurality of vehicle may include one or more locomotives, mining equipment, construction equipment, rail cars, marine vessels, or automobiles. The trigger event may include one or more of setting a data flag, outputting a message, or outputting a code. A subset of data fields of the database files may be queried periodically and, if there is no change in values of the subset of data fields of the database files, no trigger event is initiated.

In one embodiment, a method is provided that includes generating a trigger event in response to receiving and storing one or more changed pieces of vehicle information for a vehicle in a database system. The method also includes outputting vehicle identification information associated with the vehicle from the database system to a trigger queue in response to the trigger event, reading the vehicle identification information from the trigger queue, and updating a record of comprehensive vehicle information corresponding to the vehicle by pulling vehicle information corresponding to the vehicle from at least the database system based on the vehicle identification information. The method may also include accessing and reading the updated record of comprehensive vehicle information and/or displaying a representation of the vehicle in a vehicle zone showing at least a portion of the vehicle information of the comprehensive record of vehicle information. The method may include selectively displaying the changed vehicle information of the vehicle to a user and/or alerting a user that the vehicle information has changed. The alerting may include applying a rule set that indicates an imminence or severity or magnitude of the change of the vehicle information. In accordance with an embodiment, if one or more data sources of the database system are unavailable to provide updated vehicle information, the method may further include annotating the comprehensive vehicle information to indicate the unavailability of the updating of the record.

In one embodiment, a system includes a communication system configured for wireless communication with a first vehicle, a memory that stores computer-executable instructions, and one or more processors coupled to the memory and to the communication system. The one or more processors are configured to execute or facilitate execution of the computer-executable instructions to at least determine that a first portion of first vehicle information for the first vehicle is altered from a first value to a second value that is different than the first value, route (from a first data source via a computer network) the first portion of the first vehicle information that is altered to the second value, route (from a second data source via the computer network) a second portion of the first vehicle information that is not altered to the second value, store the first portion and the second portion in a first vehicle record that represents a status of the first vehicle, and generate control signals, for communication over the communication system to the first vehicle, to control movement of the first vehicle based on the first portion and the second portion stored in the first vehicle record.

Optionally, the one or more processors further execute or facilitate execution of the computer-executable instructions to control the movement of the first vehicle based on the first portion and the second portion stored in the first vehicle record.

Optionally, the one or more processors further execute or facilitate execution of the computer-executable instructions to obtain data from the first vehicle record in response to a query of a current status of the first vehicle.

Optionally, the one or more processors further execute or facilitate execution of the computer-executable instructions to route second vehicle information for a second vehicle to a second vehicle record for the second vehicle in response to a determination that at least a portion of the second vehicle information changes for the second vehicle. The second vehicle information for the second vehicle can be obtained from a plurality of data sources that comprises at least the first data source and the second data source.

Optionally, the one or more processors further execute or facilitate execution of the computer-executable instructions to communicate with a vehicle database system that includes the first data source and the second data source. The first vehicle can be in wireless communication with the vehicle database system.

Optionally, the vehicle database system includes a transportation management system in communication with the first vehicle and a second vehicle.

Optionally, the one or more processors further execute or facilitate execution of the computer-executable instructions to obtain the first portion of the first vehicle information from the vehicle database system.

Optionally, the one or more processors are in communication with the vehicle database system via a first communication protocol and the first vehicle is in communication with the vehicle database system via a different, second communication protocol.

Optionally, the one or more processors further execute or facilitate execution of the computer-executable instructions to route the first portion of the first vehicle information via one or more server computers.

In one embodiment, a system includes a communication system and a vehicle system configured to receive, over the communication system, vehicle information provided by a plurality of data sources and to store the vehicle information in a distributed manner across a plurality of database files. The vehicle system is configured to generate a trigger event in response to a determination that a first portion of the vehicle information corresponding to a first vehicle changes within the vehicle system. The system also includes a controller having one or more processors and configured to communicate with the vehicle system via the communication system. The controller is configured to update, in response to sensing the trigger event, a determined set of fields of a vehicle record corresponding to the first vehicle by obtaining the first portion of the vehicle information corresponding to the first vehicle from a first database file of the plurality of database files and obtaining a second portion of the vehicle information corresponding to the first vehicle from a second database file of the plurality of database files. The controller is configured to generate control signals, based on the first portion and the second portion of the vehicle information, relating to control of the first vehicle.

Optionally, the vehicle system is in wireless communication with the first vehicle and the first vehicle is moveable within a geographic region

Optionally, the controller is further configured to control movement of the first vehicle based on the determined set of fields that is updated.

Optionally, the system also includes the plurality of data sources, where the data sources are configured to communicate the vehicle information from the plurality of vehicles to the vehicle database system via a wireless communication system.

Optionally, the plurality of vehicles includes one or more locomotives, mining equipment, construction equipment, rail cars, marine vessels, or automobiles.

Optionally, the trigger event comprises one or more of setting a data flag, outputting a message, or outputting a code.

Optionally, the vehicle system is configured to periodically query a subset of data fields of the plurality of database files, and in response to a determination that values of the subset of data fields of the database files are unchanged, the vehicle system is configured to withhold from generating the trigger event.

In one embodiment, a system includes a vehicle system configured to receive, via a communication system, vehicle information provided by plural, different data sources disposed in different geographic locations and to store the vehicle information in a distributed manner across plural database files. The system also includes a controller having one or more processors and configured to communicate with the vehicle system via the communication system. The controller is configured to update, in response to sensing a trigger event generated by the vehicle system, a determined set of fields of a vehicle record corresponding to the first vehicle by obtaining the first portion of the vehicle information corresponding to the first vehicle from a first database file of the plural database files and obtaining a different, second portion of the vehicle information corresponding to the first vehicle from a second database file of the plural database files. The controller also is configured to generate control signals, based on the first portion and the second portion of the vehicle information, for controlling movement of the first vehicle.

Optionally, the vehicle system is in wireless communication with the first vehicle and the first vehicle is moveable within a geographic region

Optionally, the system also includes the data sources, where the data sources are configured to communicate the vehicle information from the vehicles to the vehicle system via a wireless communication system.

Optionally, the trigger event comprises one or more of setting a data flag, outputting a message, or outputting a code.

In one embodiment, a method includes generating, by a system comprising one or more processors, a trigger event in response to receiving and storing a portion of vehicle information for a vehicle in a first database system. The vehicle is movable with respect to a geographic vehicle zone. The method also includes outputting (by the system) the portion of the vehicle identification information associated with the vehicle from the first database system to a trigger queue in response to the trigger event, reading (by the system) the portion of the vehicle identification information from the trigger queue, reading (by the system) another portion of the vehicle identification information from a second database system that is different than the first database system, and updating (by the system) a record of vehicle information corresponding to the vehicle by routing the portion of the vehicle information from the trigger queue and routing the other portion of the vehicle information from the first database.

Optionally, the method also includes accessing (by the system) the record of vehicle information in response to a request for a status of the vehicle.

Optionally, the method also includes displaying (by the system) a representation of the vehicle in the geographic vehicle zone and at least the portion of the vehicle information from the record of vehicle information.

Optionally, the method also includes presenting (by the system) an alert on a user device that indicates that the portion of the vehicle information is changed, where presenting the alert includes applying a rule set that indicates a degree of the change of the portion of the vehicle information.

With reference to the drawings, like reference numerals designate identical or corresponding parts throughout the several views. However, the inclusion of like elements in different views does not mean a given embodiment necessarily includes such elements or that all embodiments of the invention include such elements.

In the specification and claims, reference will be made to a number of terms have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value.

In appended claims, the terms “including” and “having” are used as the plain language equivalents of the term “comprising”; the term “in which” is equivalent to “wherein.” Moreover, in appended claims, the terms “first,” “second,” “third,” “upper,” “lower,” “bottom,” “top,” etc. are used merely as labels, and are not intended to impose numerical or positional requirements on their objects. Further, the limitations of the appended claims are not written in means-plus-function format and are not intended to be interpreted based on 35 U.S.C. §112(f), unless and until such claim limitations expressly use the phrase “means for” followed by a statement of function void of further structure. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the inventive subject matter and also to enable one of ordinary skill in the art to practice the inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A system comprising:
a communication system configured for wireless communication with a first vehicle;
a memory that stores computer-executable instructions; and
one or more processors coupled to the memory and to the communication system, the one or more processors configured to execute or facilitate execution of the computer-executable instructions to at least:
determine that a first portion of first vehicle information for the first vehicle is altered from a first value to a second value that is different than the first value;
route, from a first data source via a computer network, the first portion of the first vehicle information that is altered to the second value;
route, from a second data source via the computer network, a second portion of the first vehicle information that is not altered to the second value;
store the first portion and the second portion in a first vehicle record that represents a status of the first vehicle; and
generate control signals, for communication over the communication system to the first vehicle, to control movement of the first vehicle based on the first portion and the second portion stored in the first vehicle record.

2. The system of claim 1, wherein the one or more processors further execute or facilitate execution of the computer-executable instructions to control the movement of the first vehicle based on the first portion and the second portion stored in the first vehicle record.

3. The system of claim 1, wherein the one or more processors further execute or facilitate execution of the computer-executable instructions to obtain data from the first vehicle record in response to a query of a current status of the first vehicle.

4. The system of claim 1, wherein the one or more processors further execute or facilitate execution of the computer-executable instructions to route second vehicle information for a second vehicle to a second vehicle record for the second vehicle in response to a determination that at least a portion of the second vehicle information changes for the second vehicle, wherein the second vehicle information for the second vehicle is obtained from a plurality of data sources that comprises at least the first data source and the second data source.

5. The system of claim 1, wherein the one or more processors further execute or facilitate execution of the computer-executable instructions to communicate with a vehicle database system that includes the first data source and the second data source, wherein the first vehicle is in wireless communication with the vehicle database system.

6. The system of claim 5, wherein the vehicle database system includes a transportation management system in communication with the first vehicle and a second vehicle.

7. The system of claim 5, wherein the one or more processors further execute or facilitate execution of the computer-executable instructions to obtain the first portion of the first vehicle information from the vehicle database system.

8. The system of claim 5, wherein the one or more processors are in communication with the vehicle database system via a first communication protocol and the first vehicle is in communication with the vehicle database system via a different, second communication protocol.

9. The system of claim 1, wherein the one or more processors further execute or facilitate execution of the computer-executable instructions to route the first portion of the first vehicle information via one or more server computers.

10. A system comprising:
a communication system;
a vehicle system configured to receive, over the communication system, vehicle information provided by a plurality of data sources and to store the vehicle information in a distributed manner across a plurality of database files, wherein the vehicle system is configured to generate a trigger event in response to a determination that a first portion of the vehicle information corresponding to a first vehicle changes within the vehicle system; and
a controller having one or more processors and configured to communicate with the vehicle system via the communication system, wherein the controller is configured to update, in response to sensing the trigger event, a determined set of fields of a vehicle record corresponding to the first vehicle by obtaining the first portion of the vehicle information corresponding to the first vehicle from a first database file of the plurality of database files and obtaining a second portion of the vehicle information corresponding to the first vehicle from a second database file of the plurality of database files,
and wherein the controller is configured to generate control signals, based on the first portion and the second portion of the vehicle information, relating to control of the first vehicle.

11. The system of claim 10, wherein the vehicle system is in wireless communication with the first vehicle and the first vehicle is moveable within a geographic region

12. The system of claim 10, wherein the controller is further configured to control movement of the first vehicle based on the determined set of fields that is updated.

13. The system of claim 10, further comprising the plurality of data sources, wherein the data sources are configured to communicate the vehicle information from the plurality of vehicles to the vehicle database system via a wireless communication system.

14. The system of claim 10, wherein the plurality of vehicles includes one or more locomotives, mining equipment, construction equipment, rail cars, marine vessels, or automobiles.

15. The system of claim 10, wherein the trigger event comprises one or more of setting a data flag, outputting a message, or outputting a code.

16. The system of claim 10, wherein the vehicle system is configured to periodically query a subset of data fields of the plurality of database files, and in response to a determination that values of the subset of data fields of the database files are unchanged, the vehicle system is configured to withhold from generating the trigger event.

17. A system comprising:
a vehicle system configured to receive, via a communication system, vehicle information provided by plural, different data sources disposed in different geographic locations and to store the vehicle information in a distributed manner across plural database files; and
a controller having one or more processors and configured to communicate with the vehicle system via the communication system, the controller configured to update, in response to sensing a trigger event generated by the vehicle system, a determined set of fields of a vehicle record corresponding to the first vehicle by obtaining the first portion of the vehicle information corresponding to the first vehicle from a first database file of the plural database files and obtaining a different, second portion of the vehicle information corresponding to the first vehicle from a second database file of the plural database files, and
wherein the controller is configured to generate control signals, based on the first portion and the second portion of the vehicle information, for controlling movement of the first vehicle.

18. The system of claim 17, wherein the vehicle system is in wireless communication with the first vehicle and the first vehicle is moveable within a geographic region

19. The system of claim 17, further comprising the data sources, wherein the data sources are configured to communicate the vehicle information from the vehicles to the vehicle system via a wireless communication system.

20. The system of claim 17, wherein the trigger event comprises one or more of setting a data flag, outputting a message, or outputting a code.
